(19) United States
(12) Patent Application Publication
(10) Pub. No.: US 2016/0223744 A1
(43) Pub. Date: Aug. 4, 2016

(54) LONG-PERIOD GRATING DEVICE AND TUNABLE GAIN FLATTENING FILTER HAVING SAME

(71) Applicant: Nano and Advanced Materials Institute Limited, Hong Kong (HK)

(72) Inventors: Yeuk Lai Hoo, Hong Kong (HK); Xin Shi, Hong Kong (HK); Tik Ho Lau, Hong Kong (HK); Peter Wai-Man Lee, Hong Kong (HK)

(21) Appl. No.: 15/008,469

(22) Filed: Jan. 28, 2016

Related U.S. Application Data
(60) Provisional application No. 62/125,699, filed on Jan. 29, 2015.

(51) Int. Cl. G02B 6/02; H01S 3/10

(52) U.S. Cl. CPC G02B 6/02204; H01S 3/1003

(57) ABSTRACT

A tunable gain flattening filter includes a long-period grating device. The long-period grating device includes: an optical fiber that includes a core having a refractive index and a core guided mode with a first effective index, and a cladding surrounding the core and having a cladding mode with a second effective index that is less than the first effective index; a thermoelectric module, the optical fiber being mounted on the thermoelectric module; a thermoelectric cooler configured to precisely control temperature of the optical fiber; and a thermistor configured as a sensor to provide feedback for the thermoelectric module. A plurality of perturbations in refractive index are defined on the core spaced apart by a periodic distance so as to form a long-period grating with a center wavelength. Diameter of the optical fiber is tapered or etched by HF solution to about 6 to 10 μm.

### CROSS-REFERENCE TO RELATED APPLICATIONS

This application claims the benefit of U.S. provisional patent application No. 62/125,699 filed on Jan. 29, 2015; the contents of which is hereby incorporated by reference.

### FIELD OF THE PATENT APPLICATION

The present patent application generally relates to optical communication and more specifically to a long-period grating device and a long-period microfiber grating based tunable gain flattening filter for gain flattening filtering and dynamic reconfiguration of an optical communication system.

### BACKGROUND

The continuing rapid growth of internet protocol (IP) traffic has been the impetus behind the extensive progress made on optical networks based on WDM systems. One way to increase network capacity is to expand the WDM wavelength range. Such a WDM system would require not only broadband amplifiers, such as Er3+-doped fiber amplifier (EDFA) and Raman amplifier, but also wideband gain flattening filter to maintain the signal power uniformity between WDM channels. Moreover, gain spectra of these amplifiers are changed by certain environmental fluctuations or when WDM channels are added/dropped, because of their inhomogeneous characteristics. Therefore, the gain flattening filter should be controlled adaptively and thus, dynamic gain flattening filter capable of adapting their on frequency response to the EDFA dynamic spectrum profile are needed to reduce amplified channel amplitude mismatches.

### SUMMARY

The present patent application is directed to a long-period grating device. In one aspect, the long-period grating device includes: an optical fiber that includes a core having a refractive index and a core guided mode with a first effective index, and a cladding surrounding the core and having a cladding mode with a second effective index that is less than the first effective index; a glass tube filled with a refractive index liquid, the optical fiber being sealed in the glass tube with UV adhesive; and a thermoelectric module, the optical fiber being mounted on the thermoelectric module. A plurality of perturbations in refractive index are defined on the core spaced apart by a periodic distance so as to form a long-period grating with a center wavelength. Diameter of the optical fiber is tapered or etched by HF solution to about 6 to 10 μm.

The long-period grating device may further include a thermoelectric cooler configured to precisely control temperature of the optical fiber. The thermoelectric cooler may be integrated to the optical fiber. The long-period grating device may further include a precision temperature controller. The precision temperature controller may be configured to use a current source or a voltage source to drive power through the thermoelectric cooler based on feedback from a temperature sensor.

The long-period grating device may further include a thermistor configured as a sensor to provide feedback for the thermoelectric module. The thermistor may be a resistor that changes resistance with temperature. The thermistor may have a Negative Temperature Coefficient (NTC).

In another aspect, the present patent application provides a tunable gain flattening filter including a long-period grating device. The long-period grating device includes: an optical fiber that includes a core having a refractive index and a core guided mode with a first effective index, and a cladding surrounding the core and having a cladding mode with a second effective index that is less than the first effective index; a thermoelectric module, the optical fiber being mounted on the thermoelectric module; a thermoelectric cooler configured to precisely control temperature of the optical fiber; and a thermistor configured as a sensor to provide feedback for the thermoelectric module. A plurality of perturbations in refractive index are defined on the core spaced apart by a periodic distance so as to form a long-period grating with a center wavelength. Diameter of the optical fiber is tapered or etched by HF solution to about 6 to 10 μm.

The tunable gain flattening filter may further include a glass tube filled with a refractive index liquid. The optical fiber may be sealed in the glass tube with UV adhesive. The thermistor may be a resistor that changes resistance with temperature.

In yet another aspect, the present patent application provides a long-period grating device including: an optical fiber that includes a core having a refractive index and a core guided mode with a first effective index, and a cladding surrounding the core and having a cladding mode with a second effective index that is less than the first effective index. A plurality of perturbations in refractive index are defined on the core spaced apart by a periodic distance so as to form a long-period grating with a center wavelength. Diameter of the optical fiber is tapered or etched by HF solution to about 6 to 10 μm.

The long-period grating device may further include a glass tube filled with a refractive index liquid. The optical fiber may be sealed in the glass tube with UV adhesive. The long-period grating device may further include a thermoelectric module. The optical fiber may be mounted on the thermoelectric module. The long-period grating device may further include a thermoelectric cooler configured to precisely control temperature of the optical fiber. The thermoelectric cooler may be integrated to the optical fiber.

The long-period grating device may further include a precision temperature controller. The precision temperature controller may be configured to use a current source or a voltage source to drive power through the thermoelectric cooler based on feedback from a temperature sensor. A precision current source of the precision temperature controller may be configured to drive current through the temperature sensor, and thereby provide a voltage feedback.

The long-period grating device may further include a thermistor configured as a sensor to provide feedback for the thermoelectric module. The thermistor may be a resistor that changes resistance with temperature. The thermistor may have a Negative Temperature Coefficient (NTC).

### BRIEF DESCRIPTION OF THE DRAWINGS

FIG. 1 illustrates a coupler fabrication station for fabricating a long-period grating device in accordance with an embodiment of the present patent application.

FIG. 2 shows a system for fabricating long period grating (LPG) in microfibers.

FIG. 3 (a) shows a microscope image of periodical micro-tapers created on a microfiber with a diameter of 6.3 μm after 15 scanning cycles.

FIG. 3 (b) is a microscope image of a micro-tapered region.

FIG. 3 (c) is a SEM image of a micro-tapered region.

FIG. 4 is a schematic diagram of a liquid immersed long period grating.

FIG. 5 is a schematic diagram of liquid immersed long period grating mounted on a thermoelectric module.

### DETAILED DESCRIPTION

Reference will now be made in detail to a preferred embodiment of the long-period grating device and the tunable gain flattening filter having the same disclosed in the present patent application, examples of which are also provided in the following description. Exemplary embodiments of the long-period grating device and the tunable gain flattening filter having the same disclosed in the present patent application are described in detail, although it will be apparent to those skilled in the relevant art that some features that are not particularly important to an understanding of the long-period grating device and the tunable gain flattening filter having the same may not be shown for the sake of clarity.

Furthermore, it should be understood that the long-period grating device and the tunable gain flattening filter having the same disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

According to an embodiment of the present patent application, a tunable gain flattening filter includes a long-period grating device having enhanced sensitivity of refractive index. The long-period grating device includes an optical fiber. The optical fiber includes a core having a refractive index and a core guided mode with a first effective index; and a cladding surrounding the core and having a cladding mode with a second effective index that is less than the first effective index. A plurality of perturbations in refractive index are defined on the core spaced apart by a periodic distance so as to form a long-period grating with a center wavelength. Diameter of the optical fiber is tapered or etched by HF solution to about 6 to 10 μm.

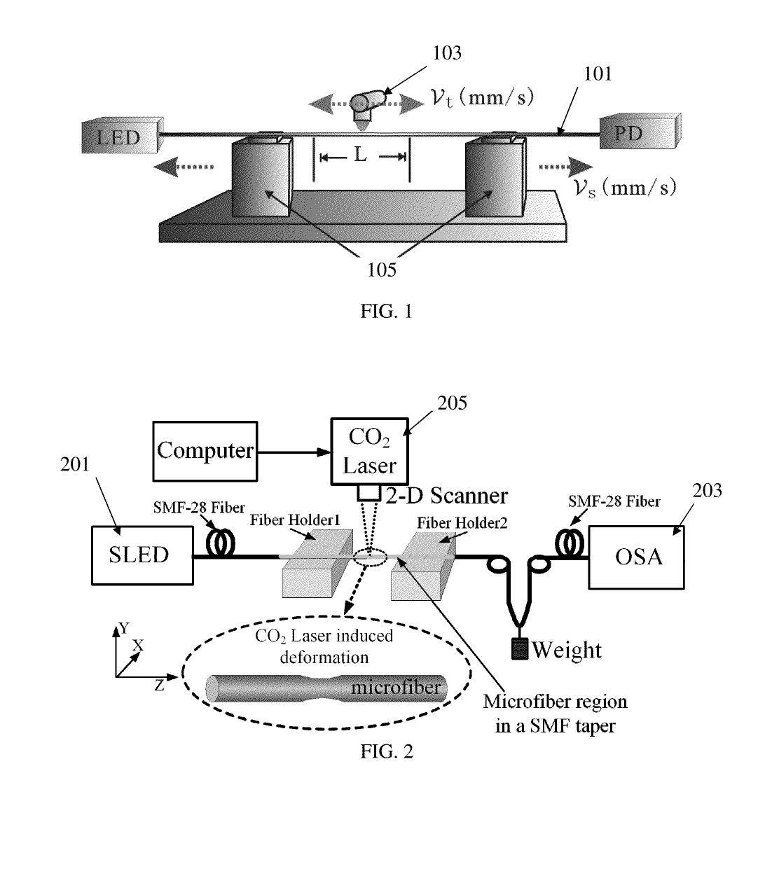

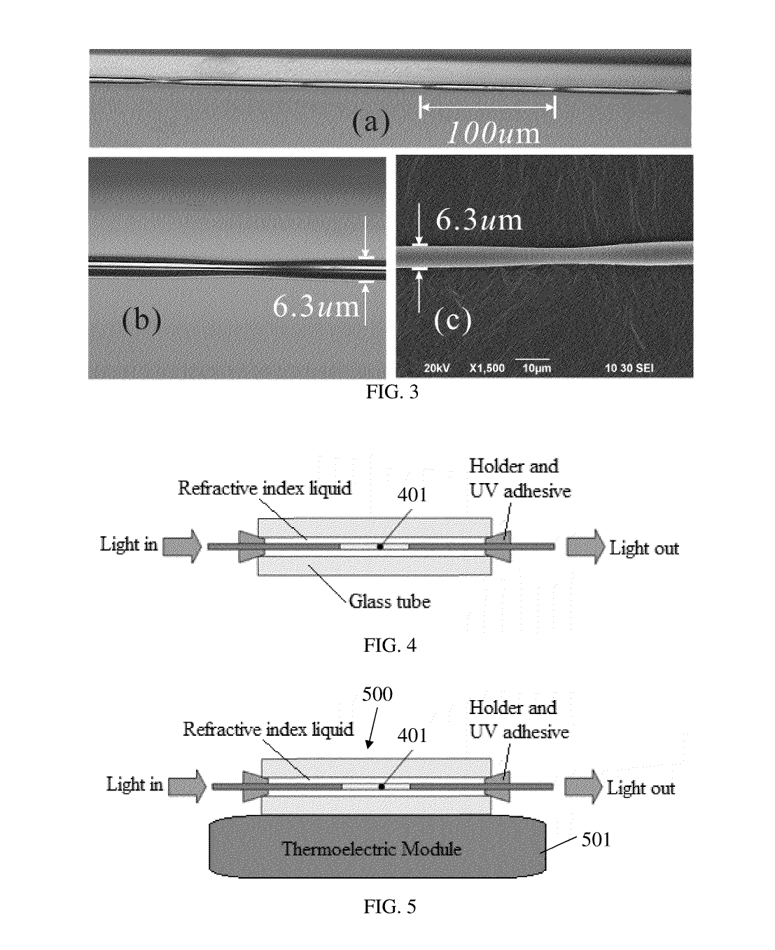

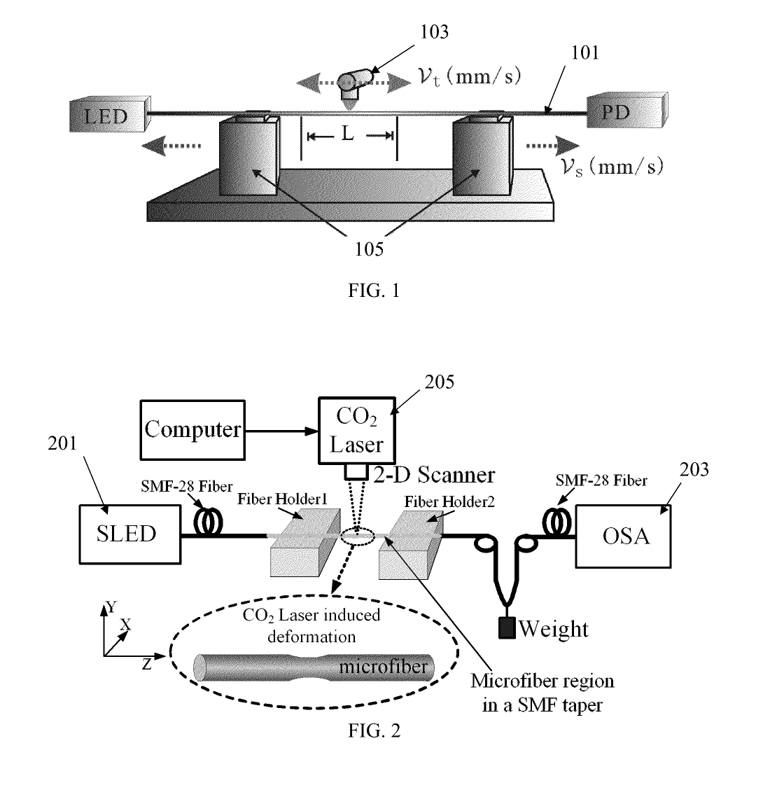

FIG. 1 illustrates a coupler fabrication station for fabricating a long-period grating device in accordance with an embodiment of the present patent application. A method of fabricating a Long Period Microfiber Grating in accordance with the embodiment is described hereafter. The microfibers are drawn by tapering single mode fibers (SMFs) with a commercial coupler fabrication station as shown in FIG. 1. Referring to FIG. 1, a commercial SMF (outer diameter D of 125 μm) is used and pulled to the scale of a few microns. The SMF 101 is heated and softened by a hydrogen flame, whose dimension along the fiber is about 8 mm. A flame torch 103 is scanned along the fiber, while the two translation stages 105 holding the fiber are symmetrically moved apart. With proper fabrication parameters, microfibers with diameter from hundreds of nanometers to a few micrometers and effective waist lengths longer than about 30 mm can be fabricated. Since a microfiber (the waist of taper) is adiabatically taper-pulled from a SMF, it is automatically connected to its SMF pigtails. This guarantees that the fundamental HE₁₁ mode of the microfiber is excited with approaching 100% efficiency while other modes of the microfiber are largely not excited.

FIG. 2 shows a system for fabricating long period grating (LPG) in microfibers. Referring to FIG. 2, two SMF pigtails of the microfiber are respectively connected to a Light-Emitting Diode (LED) 201 and an optical spectrum analyzer (OSA) 203. A CO2 laser 205 is adjusted to have the following parameters: pulses width 2.0 μs, repetition rate 10 kHz, and average power about 0.02 W. This power level is significantly smaller than the one used for LPG fabrication in normal-size optical fibers. The CO2 beam is focused to a spot with about 30 μm in diameter and has an about 50 μm depth of focus, and the size of focal spot is considerably larger than the diameter of the microfiber. The focused beam can be scanned, via a computer controlled two-dimensional optical scanner, transversely and longitudinally as instructed by a preprogrammed routing. During the fabrication, the laser beam is firstly scanned transversely across the microfiber and then moved longitudinally by a step of grating pitch (e.g. Λ˜100 μm) to have a second scan. This procedure is repeated for N times in order to fabricate a LPG with N−1 periods. The process of making N successive transverse scans is referred to as one scanning cycle. By controlling the number of scanning cycles, the depth of the attenuation dip in the transmission can be controlled.

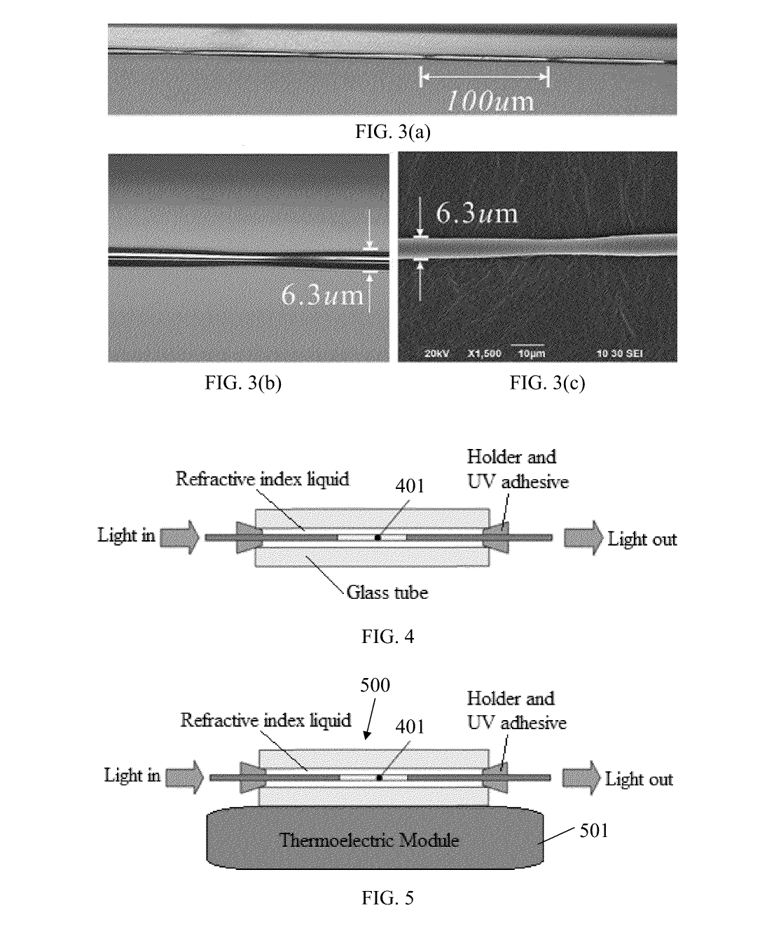

During scanning, the high-frequency CO2 laser pulses hit repeatedly on the microfiber and induce a local high temperature to soften the silica of the fiber. By applying a small weight as shown in FIG. 2, a small constant longitudinal tensile strain is induced and the soften region, i.e., the CO2 laser hit region, of the microfiber will be drawn slightly, which creates a micro-taper. FIG. 3 (a) shows the microscope image of periodical micro-tapers created on a microfiber with a diameter of 6.3 μm after 15 scanning cycles. FIG. 3 (b) and FIG. 3 (c) are respectively the microscope and SEM images of a micro-tapered region. The diameter of micro-taper waist shown in the FIG. 3 (b) and FIG. 3 (c) is about 6.5 percent of the microfiber, while the length of micro-taper is about 35 μm.

FIG. 4 is a schematic diagram of a liquid immersed long period grating. FIG. 5 is a schematic diagram of liquid immersed long period grating mounted on a thermoelectric module. Referring to FIG. 4 and FIG. 5, the long period microfiber grating 401 is sealed in a refractive index liquid filled glass tube with UV adhesive and then mounted on a thermoelectric module 501 in order to vary the temperature, which, therefore, provides thermal tunability to the transmission spectrum.

A thermoelectric cooler (i.e. actuator) is used to precisely control the temperature and thermistor is used as a sensor and to provide feedback for the controller. The liquid immersed long period grating 500 is placed onto the thermoelectric module 501, allowing for temperature regulation. The thermoelectric cooler (i.e. actuator) is used to precisely control the temperature of the filter and integrated to the thermoelectric module 501. A precision temperature controller uses a current or voltage source to drive power through these actuators based on feedback from the temperature sensor. To provide feedback for the controller, the temperature sensor is configured to measure actual temperature and convert the temperature measurement to a voltage input. A common sensor is a thermistor, which is a resistor that changes resistance with temperature. Most thermistors have Negative Temperature Coefficient (NTC). A precision current source of the temperature controller drives current through the sensor, providing a voltage feedback for the control system.

In the above embodiments, a tunable, low-cost and compact, all-in-fiber gain flattening filter based on thermal control of a long period microfiber grating immersed into a thermal sensitive index liquid is provided. The features of tunable, low-cost and compact of the devices are designed for gain flattening and dynamic reconfiguration of optical communication system. This highly tunable feature can be used as a tunable gain flattening filter which can be dynamically adjusted to meet the requirement on the high degree of flexibility and the increase of complexity of the optical communication system nowadays. Long-period microfiber grating is much more sensitive to the surrounded environment than that of the conventional long-period fiber grating. Thus the long-period microfiber grating is highly tunable when it is immersed into a thermal sensitive index liquid. Optical gain flattening filter is extensively used as key components in optical communications. The tunability of the bandwidth represents a degree of freedom well desired in this application. The gain flatness of ±0.5 dB over the C band (1530-1565 nm) by using a cascade tunable gain flattening filter system with 20 nm spectral shift of the EDFA and 20 nm notch shift in the temperature range of 20-51° C. can be realized.

The use of tunable gain flattening filter (TGFF) periodically throughout the network eliminates the need for numerous fixed-gain filters and allows amplifier flatness specification to be relaxed, and thereby decreases the system cost and increases the operational flexibility. This allows easy upgradability, cost effectiveness, and large channel handling capability or spectral resolution. Thus it leads to the increase of speed and capacity of data transmission and decrease of the fee of communication services.

The above embodiments provide a tunable, low-cost and compact, all-in-fiber gain flattening filter which provides large dynamic adjustable range and much easier for packaging. As the thermal characteristics of the device can be controlled automatically by thermal energy converter cooler, the method offers great applications for dynamic gain flattening of EDFAs.

The features of tunable, low-cost and compact of the devices are designed to target the market of gain flattening application and the increase of requirement of dynamic reconfiguration of the fiber optic communication. The Tunable gain flattening filter (TGFF) can be a key component in high capacity and high speed (10 or 40 GBit/s) long haul transmission systems. The TGFF has been tested in ‘live’ optical communication networks to dynamically adjust the gain profile for the entire C-band or L-band wavelength range. The cost of the device is much lower than that of the products in the market such as thermo-optic phase shifters, fiber acousto-optic tunable filters, and high-birefringence fiber loop mirror. Therefore, low cost is one of the main advantages and strengths of the device. Not only it is competitive but also it can enhance the competitiveness of the other systems and products (e.g. optical amplifier) in which the device provided by the embodiments is one of the components. Furthermore, the increase of speed and capacity of the communication system lead to the decrease of system cost and the fee of communication services. These results would bring social benefit in both individual and economy.

In the above embodiments, a tunable all-in-fiber gain flattening filter based on the immersion of long period fiber grating into an index liquid with high temperature effect on refractive index is provided. In order to achieve the highly tunable function, the diameter of the optical fiber should be reduced to about tens to even several micrometers in order to enhance the fraction of evanescent fields as well as the sensitivity to the environmental refractive index change, which leads to the high shift of the notch. The tunability is realized by adjusting the temperature of the refractive index liquid, which leads to the change of the refractive index of the liquid. Throughout the specification, such long period grating with several micrometers diameter may also be referred to as “long period microfiber grating”.

In the above embodiments, the significant increase of sensitivity of refractive index can be achieved by reducing the diameter of the long period grating to a micro-scale. They have further determined that this Long Period Microfiber Grating (LPMFG) provides a dynamic gain flattening of EDFAs as well as a dynamic reconfiguration of optical communication system. The microfibers for LPMFG fabrication are drawn by tapering conventional single mode fiber with a commercial coupler fabrication station. A commercial single mode fiber (outer diameter being 80 to 125 micron) is pulled to the scale of tens to few microns. The long period grating is then fabricated onto the microfibers by using a CO2 laser. The long period microfiber grating is sealed in a refractive index liquid filled glass tube with UV adhesive and then whole device is placed onto the thermoelectric module. The tunable filtering of the device functions by inducing a refractive index change on the refractive index liquid as well as the grating surface through the thermoelectric module, thereby shifting the resonance wavelength of the LPMFG in a range of 1530-1565 nm The gain flatness of ±0.5 dB over the C band (1530-1565 nm) is achieved by using a cascade tunable gain flattening filter system with 20 nm spectral shift of erbium-doped fiber amplifier (EDFA).

Good flexibility and linearity for the control of the liquid immersed microfiber long period grating performance can provide a wide dynamic range for the flattening of the gain profile of an EDFA based on the temperature characteristics of the device. The liquid immersed microfiber long period grating can be used to flatten the gain profile of an EDFA pumped at 980 nm The gain flatness achieved can be about ±0.5 dB over a bandwidth of ˜35 nm. When the pumping power at 980 nm is changed, similar results are obtained by readjusting the central wavelength of the device by means of temperature variations.

While the present patent application has been shown and described with particular references to a number of embodiments thereof, it should be noted that various other changes or modifications may be made without departing from the scope of the present invention.

What is claimed is:

1. A long-period grating device comprising:
an optical fiber that comprises a core having a refractive index and a core guided mode with a first effective index, and a cladding surrounding the core and having a cladding mode with a second effective index that is less than the first effective index;
a glass tube filled with a refractive index liquid, the optical fiber being sealed in the glass tube with UV adhesive; and
a thermoelectric module, the optical fiber being mounted on the thermoelectric module;
wherein:
a plurality of perturbations in refractive index are defined on the core spaced apart by a periodic distance so as to form a long-period grating with a center wavelength; and
diameter of the optical fiber is tapered or etched by HF solution to about 6 to 10 μm.

2. The long-period grating device of claim 1 further comprising a thermoelectric cooler configured to precisely control temperature of the optical fiber.

3. The long-period grating device of claim 2, wherein the thermoelectric cooler is integrated to the optical fiber.

4. The long-period grating device of claim 2 further comprising a precision temperature controller, wherein the precision temperature controller is configured to use a current source or a voltage source to drive power through the thermoelectric cooler based on feedback from a temperature sensor.

5. The long-period grating device of claim 1 further comprising a thermistor configured as a sensor to provide feedback for the thermoelectric module.

6. The long-period grating device of claim 5, wherein the thermistor is a resistor that changes resistance with temperature.

7. The long-period grating device of claim 6, wherein the thermistor has a Negative Temperature Coefficient (NTC).

8. A tunable gain flattening filter comprising a long-period grating device, the long-period grating device comprising:
an optical fiber that comprises a core having a refractive index and a core guided mode with a first effective index, and a cladding surrounding the core and having a cladding mode with a second effective index that is less than the first effective index;
a thermoelectric module, the optical fiber being mounted on the thermoelectric module;
a thermoelectric cooler configured to precisely control temperature of the optical fiber; and
a thermistor configured as a sensor to provide feedback for the thermoelectric module;
wherein:
a plurality of perturbations in refractive index are defined on the core spaced apart by a periodic distance so as to form a long-period grating with a center wavelength; and
diameter of the optical fiber is tapered or etched by HF solution to about 6 to 10 μm.

9. The tunable gain flattening filter of claim 8 further comprising a glass tube filled with a refractive index liquid, wherein the optical fiber is sealed in the glass tube with UV adhesive.

10. The tunable gain flattening filter of claim 8, wherein the thermistor is a resistor that changes resistance with temperature.

11. A long-period grating device comprising:
an optical fiber that comprises a core having a refractive index and a core guided mode with a first effective index, and a cladding surrounding the core and having a cladding mode with a second effective index that is less than the first effective index; wherein:
a plurality of perturbations in refractive index are defined on the core spaced apart by a periodic distance so as to form a long-period grating with a center wavelength; and
diameter of the optical fiber is tapered or etched by HF solution to about 6 to 10 μm.

12. The long-period grating device of claim 11 further comprising a glass tube filled with a refractive index liquid, wherein the optical fiber is sealed in the glass tube with UV adhesive.

13. The long-period grating device of claim 11 further comprising a thermoelectric module, wherein the optical fiber is mounted on the thermoelectric module.

14. The long-period grating device of claim 13 further comprising a thermoelectric cooler configured to precisely control temperature of the optical fiber.

15. The long-period grating device of claim 14, wherein the thermoelectric cooler is integrated to the optical fiber.

16. The long-period grating device of claim 14 further comprising a precision temperature controller, wherein the precision temperature controller is configured to use a current source or a voltage source to drive power through the thermoelectric cooler based on feedback from a temperature sensor.

17. The long-period grating device of claim 16, wherein a precision current source of the precision temperature controller is configured to drive current through the temperature sensor, and thereby provide a voltage feedback.

18. The long-period grating device of claim 13 further comprising a thermistor configured as a sensor to provide feedback for the thermoelectric module.

19. The long-period grating device of claim 18, wherein the thermistor is a resistor that changes resistance with temperature.

20. The long-period grating device of claim 19, wherein the thermistor has a Negative Temperature Coefficient (NTC).
